(19) United States
(12) Patent Application Publication
(10) Pub. No.: US 2007/0091791 A1
(43) Pub. Date: Apr. 26, 2007

(54) RPR span BW protection scheme for RPR transported over SONET paths

(75) Inventor: Michael Charles Green, Central Valley, NY (US)

Correspondence Address: Edward A. Pennington;SWIDLER BERLIN LLP, Suite 300, 3000 K Street NW, Washington, DC, 20007, US

(73) Assignee: Fujitsu Network Communications, Inc.

(21) Appl. No.: 11/253,725

(22) Filed: Oct. 20, 2005

(51) Int. Cl. H04L 12/26

(52) U.S. Cl. 370/222

(57) ABSTRACT

A communication system and method provide fractional protection of Resilient Packet Ring (RPR) span bandwidth (BW) by provisioning the number of SONET paths in a given span to greater than the RPR ring BW. A communication system comprises a plurality of Synchronous Optical Network paths, a Resilient Packet Ring span implemented using the plurality of Synchronous Optical Network paths, and a Link Capacity Adjustment Scheme operable, in response to failure of a Synchronous Optical Network path implementing the Resilient Packet Ring span, to remove the failed Synchronous Optical Network path from implementing the Resilient Packet Ring span and to redistribute the Resilient Packet Ring traffic over the remaining Synchronous Optical Network paths.

### BACKGROUND OF THE INVENTION

1. Field of the Invention

The present invention relates to fractional protection of Resilient Packet Ring (RPR) span bandwidth (BW) by provisioning the number of SONET paths in a given span to greater than the RPR ring BW.

2. Description of the Related Art

Resilient Packet Ring (RPR), specified in IEEE standard 802.17, is a standard designed for the optimized transport of data traffic over fiber rings. It is designed to provide the resilience found in SONET/SDH networks (50 ms protection), but instead of setting up circuit oriented connections, it provides a packet-based transmission. This is to increase the efficiency of Ethernet and IP services.

RPR works on a concept of dual counter rotating rings called ringlets. These ringlets are setup by creating RPR stations at nodes where traffic is supposed to drop, per flow (a flow is the ingress and egress of data traffic). Each ring segment used to transport data between stations is referred to as a span. RPR uses MAC (Media Access Control protocol) messages to direct the traffic, which traverses both directions around the ringlet. The nodes also negotiate for bandwidth among themselves using fairness algorithms, avoiding congestion and failed spans. The avoidance of failed spans is accomplished by using one of two techniques known as “steering” and “wrapping”. Under steering if a node or span is broken all nodes are notified of a topology change and they reroute their traffic. In wrapping the traffic is looped back at the last node prior to the break and routed to the destination station.

All traffic on the ring is assigned a Class of Service (CoS) and the standard specifies three classes. Class A (or High) traffic is a pure CIR (Committed Information Rate) and is designed to support applications requiring low latency and jitter, such as voice and video. Class B (or Medium) traffic is a mix of both a CIR and an EIR (Excess Information Rate—which is subject to fairness queuing). Class C (or Low) is best effort traffic, utilizing whatever bandwidth is available. This is primarily used to support internet access traffic.

When RPR is implemented using SONET as the transport technology between stations, a span is composed of one or more SONET paths that typically employ virtual concatenation to provide multiplexed transport of data over all paths in the span. All spans in a given RPR ring must be configured to at least carry the designated ring data bandwidth (BW); i.e. the RPR ring BW must less than or equal to span BW. Current RPR deployments envision that RPR span BW is equal to the RPR Ring BW and that if a span BW is protected against failure, the additional protection BW provisioned equals the Ring BW. This requirement of current systems that the protection BW equal the ring BW results in a relatively inefficient use of the system BW. Alternatively, if protection BW is not used, then a single SONET path failure cases the entire RPR span to fail. A need arises for a protection scheme that provides adequate protection, yet is more BW efficient than current schemes.

### SUMMARY OF THE INVENTION

In the present invention, the span BW is fractionally protected by provisioning the number of SONET paths in a given span to greater than the RPR ring BW.

In one embodiment of the present invention, a communication system comprises a plurality of Synchronous Optical Network paths, a Resilient Packet Ring span implemented using the plurality of Synchronous Optical Network paths, and a Link Capacity Adjustment Scheme operable, in response to failure of a Synchronous Optical Network path implementing the Resilient Packet Ring span, to remove the failed Synchronous Optical Network path from implementing the Resilient Packet Ring span and to redistribute the Resilient Packet Ring traffic over the remaining Synchronous Optical Network paths.

In one aspect of the present invention, the Link Capacity Adjustment Scheme may be further operable, in response to clearance of the failure of the failed Synchronous Optical Network path, to redistribute the Resilient Packet Ring traffic over the plurality of Synchronous Optical Network paths including the cleared Synchronous Optical Network path. The Synchronous Optical Network paths may be assigned to implement the Resilient Packet Ring span using a Virtual Concatenation Group. The plurality of Synchronous Optical Network paths may have a first bandwidth, the Resilient Packet Ring span may have a second bandwidth, and the first bandwidth may be greater than the second bandwidth.

### BRIEF DESCRIPTION OF THE DRAWINGS

The preferred embodiments of the present invention will be described with reference to the accompanying drawings.

FIG. 1 is an exemplary block diagram of an RPR ring structure.

FIG. 2 is an exemplary block diagram of a station in the RPR ring structure shown in FIG. 1.

FIG. 3 is an exemplary block diagram of fractional protection of RPR span bandwidth using SONET paths.

FIG. 4 is an exemplary diagram of fractional protection of RPR span bandwidth using SONET paths.

FIG. 5 is an exemplary flow diagram of a process of fractional protection of RPR span bandwidth using SONET paths.

### DETAILED DESCRIPTION OF THE PREFERRED EMBODIMENTS

In the present invention, the span BW is fractionally protected by provisioning the number of SONET paths in a given span to greater than the RPR ring BW.

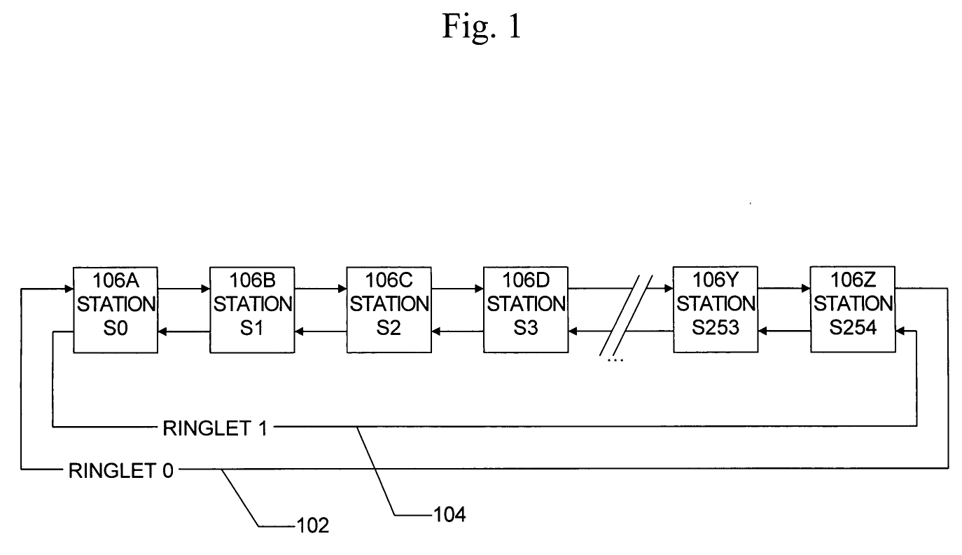

An example of an RPR ring structure 100 is shown in FIG. 1. RPR employs a ring structure using unidirectional, counter-rotating ringlets. Each ringlet is made up of links with data flow in the same direction. The ringlets are identified as ringlet0 102 and ringlet1 104, as shown in FIG. 1. The association of a link with a specific ringlet is not altered by changes in the state of the links or stations. Stations on the ring, such as stations 106A-N, are identified by an IEEE 802 48-bit MAC address as specified in IEEE Std. 802-2002. All links on the ring operate at the same data rate, but they may exhibit different delay properties. The portion of a ring bounded by adjacent stations is called a span. A span is composed of unidirectional links transmitting in opposite directions. StationY is said to be a downstream neighbor of stationX on ringlet0 102/1 if the stationX traffic becomes the receive traffic of stationY on the referenced ringlet. Thus, station S5 is the downstream neighbor of station S4 on ringlet0 102; similarly station S2 is the downstream neighbor of station S3 on ringlet1 104. StationY is said to be an upstream neighbor of stationX on ringlet0/1 102,104 if the stationY traffic becomes the receive traffic of station X on the referenced ringlet. Thus, station S4 is the upstream neighbor of station S5 on ringlet0 102; similarly station S3 is the upstream neighbor of station S2 on ringlet1 104.

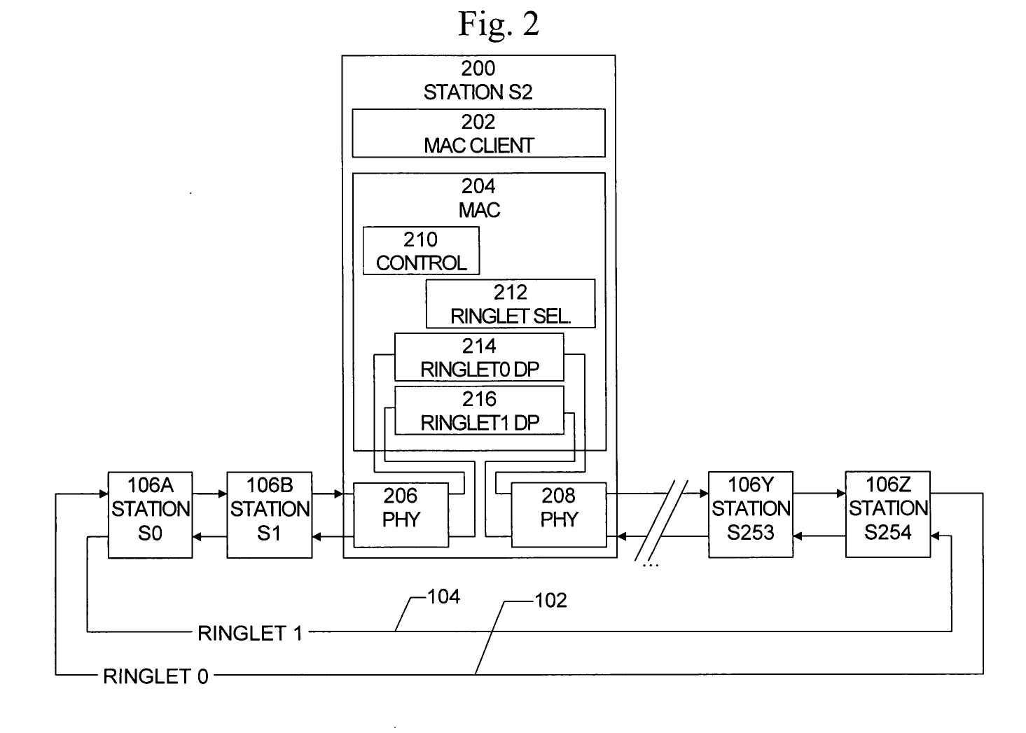

An example of a station 200 in an RPR ring structure 100 is shown in FIG. 2. Station 200 includes one client entity 202, one MAC entity 204, and two PHY entities 206, 208. Each PHY 206, 208 is associated with a span shared with a neighboring station. The MAC entity 204 contains one MAC control entity 210, a ringlet selection entity 212, and two datapath entities 214, 216 (one datapath is associated with each ringlet). The PHY 208 transmitting on ringlet0 102 and receiving on ringlet1 104 is identified as the east PHY 208. The PHY 206 transmitting on ringlet1 104 and receiving on ringlet0 102 is identified as the west PHY 206. The ringlet0 102 datapath receives frames from the west PHY 206 and transmits or retransmits frames on the east PHY 208. The ringlet1 104 datapath receives frames from the east PHY 208 and transmits or retransmits frames on the west PHY 206.

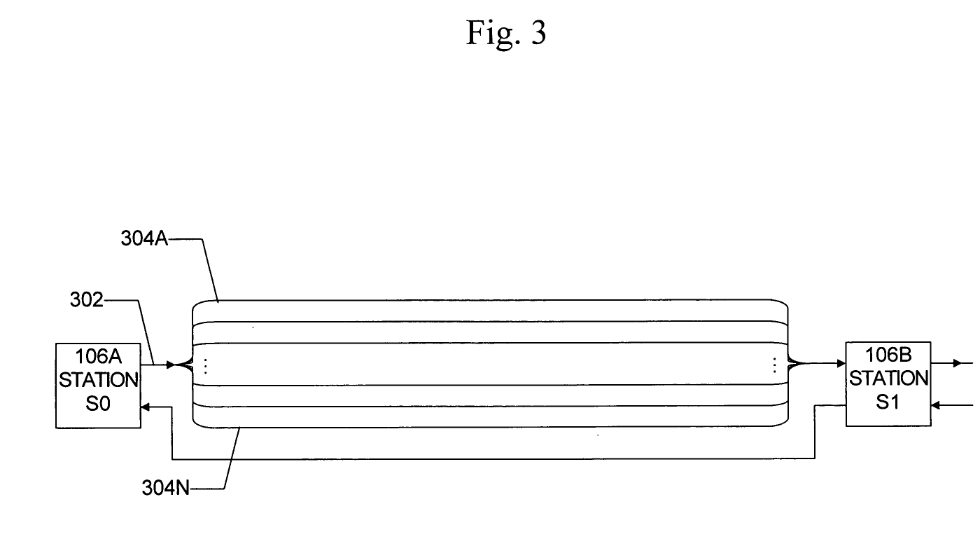

In the present invention, the span BW is fractionally protected by provisioning the number of SONET paths in a given span to greater than the RPR ring BW. An example of this arrangement is shown in FIG. 3. In the example shown in FIG. 3, a ringlet span 302 is made up of a plurality of SONET paths 304A-N. Each SONET path, for example, SONET path 304A, carries traffic using a Link Capacity Adjustment Scheme (LCAS). LCAS provides for virtual concatenation (VCAT) of Synchronous Optical Network (SONET) paths, which may be either virtual tributaries (VTs) or synchronous transport signals (STSs). As specified in these industry standards, LCAS employs both manual or management triggered link addition/removal procedures and automatic addition/removal procedures in a single state machine scheme.

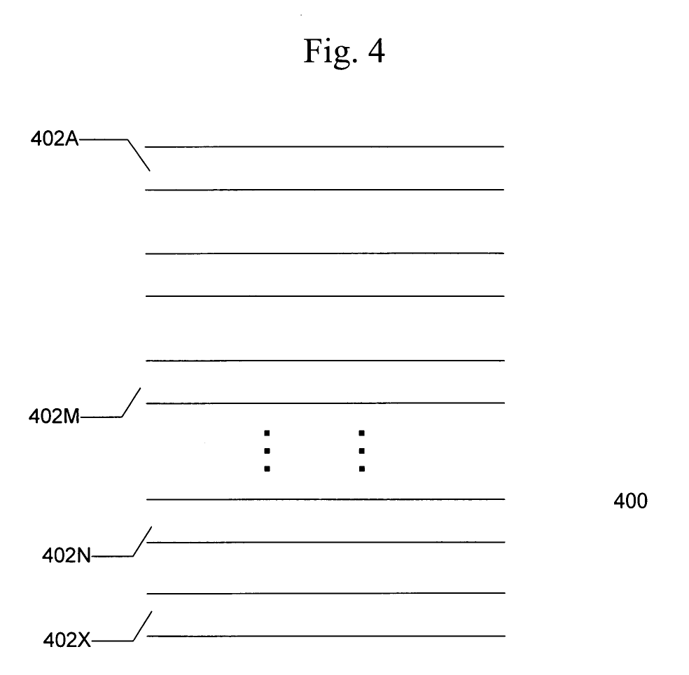

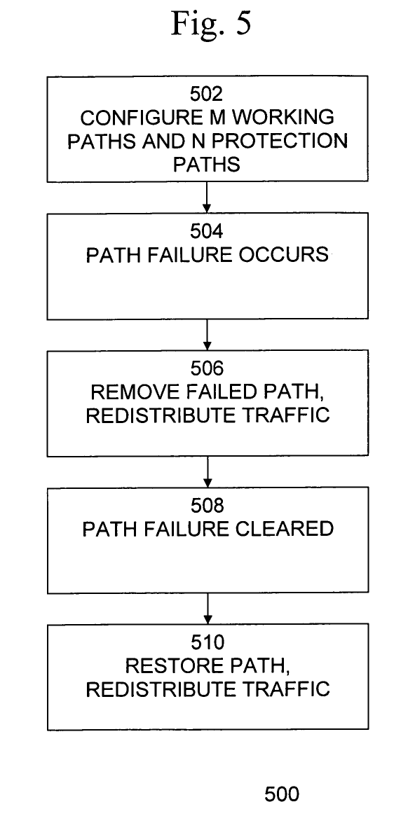

In order to provide fractional protection of an RPR span, all of the SONET paths in the span need to employ LCAS procedures to remove failed SONET paths from the virtual concatenated group of SONET paths (VCG). An example of this is illustrated in FIG. 4, in which an RPR span 400 includes a plurality of SONET paths 402A-X. It is best viewed in conjunction with FIG. 5, which illustrates a process 500 of operation of this technique. Process 500 begins with step 502, in which working and protection SONET paths are configured. Taking the RPR Ring BW in units of the BW for a single SONET path, such as 402A, then let m be the number of SONET paths 402A-M whose total BW equals the RPR ring BW. Also, let n be the number of additional SONET paths 402N-X that are included in a VCG serving a given RPR span. Since LCAS distributes the traffic over the available paths, each of the paths carries traffic at less than its maximum bandwidth. This may be referred to as “n:m protection” (n for m protection). The total number of paths k in the VCG is, k=n+m. In this scheme, LCAS is employed for the k paths of the VCG in a span.

In step 504, a path failure occurs. In step 506, LCAS causes the “removal” of the failed path from the group of VCG paths that are actively carrying BW in the span and redistribution of the traffic over the remaining paths. For example, if SONET path 402A fails, LCAS will remove path 402A from the group of VCG paths that are actively carrying BW in the span and will redistribute the traffic that was being carried by path 402A to the remaining paths. Preferably, the RPR stations permit such BW reductions to occur while only causing momentary span failures (equal to the duration between a path failure occurrence to its removal) as long as the resulting VCG BW is greater than or equal to the RPR Ring BW. This scheme permits the up to n SONET path failures on a given RPR span before such a path failure causes a prolonged RPR span failure of a duration equal to that of the SONET path failure.

In step 508, the failed path in the VCG is becomes operational (failure cleared). In step 510, LCAS restores this path to those paths actively carrying BW in the span in a “hitless” fashion (as per LCAS standard). Hitless means the path restoration occurs without even a momentary SPAN failure. This hitless recovery is a feature of the LCAS standard. Once the path is restored, the LCAS redistributes the traffic over all operational paths, including the restored path.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A communication system comprising:
a plurality of Synchronous Optical Network paths;
a Resilient Packet Ring span implemented using the plurality of Synchronous Optical Network paths; and
a Link Capacity Adjustment Scheme operable, in response to failure of a Synchronous Optical Network path implementing the Resilient Packet Ring span, to remove the failed Synchronous Optical Network path from implementing the Resilient Packet Ring span and to redistribute the Resilient Packet Ring traffic over the remaining Synchronous Optical Network paths.

2. The communication system of claim 1, wherein the Link Capacity Adjustment Scheme is further operable, in response to clearance of the failure of the failed Synchronous Optical Network path, to redistribute the Resilient Packet Ring traffic over the plurality of Synchronous Optical Network paths including the cleared Synchronous Optical Network path.

3. The communication system of claim 2, wherein the Synchronous Optical Network paths are assigned to implement the Resilient Packet Ring span using a Virtual Concatenation Group.

4. The communication system of claim 1, wherein the plurality of Synchronous Optical Network paths has a first bandwidth, the Resilient Packet Ring span has a second bandwidth, and the first bandwidth is greater than the second bandwidth.

5. A method of operating a communication system comprising a plurality of Synchronous Optical Network paths, the method comprising:
implementing a Resilient Packet Ring span using a plurality of Synchronous Optical Network paths; and
in response to failure of a Synchronous Optical Network path implementing the Resilient Packet Ring span, removing the failed Synchronous Optical Network path from implementing the Resilient Packet Ring span and redistributing the Resilient Packet Ring traffic over the remaining Synchronous Optical Network paths.

6. The method of claim 5, further comprising:
in response to clearance of the failure of the failed Synchronous Optical Network path, redistributing the Resilient Packet Ring traffic over the plurality of Synchronous Optical Network paths including the cleared Synchronous Optical Network path.

7. The method of claim 6, wherein the Resilient Packet Ring span is implemented using a Link Capacity Adjustment Scheme.

8. The method of claim 7, wherein the Resilient Packet Ring span is implemented using a Virtual Concatenation Group.

9. The method of claim 5, wherein the plurality of Synchronous Optical Network paths has a first bandwidth, the Resilient Packet Ring span has a second bandwidth, and the first bandwidth is greater than the second bandwidth.
